(19) United States
(12) Patent Application Publication
(10) Pub. No.: US 2005/0201375 A1
(43) Pub. Date: Sep. 15, 2005

(54) Uninterrupted transfer method in IP network in the event of line failure

(76) Inventors: Yoshihide Komatsu, Yokohama (JP); Hirofumi Yagawa, Yokohama (JP); Kazuya Ryu, Yokohama (JP); Kazuaki Yoshida, Yokohama (JP); Toshinobu Tsunematsu, Yokohama (JP)

Correspondence Address: KATTEN MUCHIN ROSENMAN LLP, 575 MADISON AVENUE, NEW YORK, NY, 10022-2585, US

(21) Appl. No.: 11/122,381

(22) Filed: May 5, 2005

Related U.S. Application Data
(63) Continuation of application No. PCT/JP03/00186, filed on Jan. 14, 2003.

(51) Int. Cl. H04L 12/28

(52) U.S. Cl. 370/389

(57) ABSTRACT

An uninterruptible transfer can be realized during a line failure in a transmission system performing a packet transmission between transmitting apparatuses connected via a plurality of lines. In a method for realizing the uninterruptible transfer, test packets including information of the number of packets received from the transmitting apparatus of a destination are periodically sent to the transmitting apparatus of a source. The transmitting apparatus of the source compares the received information of the number of packets included in the received test packets with the number of packets sent out to the transmitting apparatus of the destination via one line. When the comparison shows a disagreement between the number of the received packets and the number of the sent-out packets, packets corresponding to the disagreement are resent to the transmitting apparatus of the destination via another line. The packets, before being sent out to the transmitting apparatus of the destination, are stored in a buffer memory. When the comparison shows an agreement between the number of the received packets and the number of the sent-out packets, packets, which are stored in the buffer memory, corresponding to the agreement are released from the buffer memory.

### FIELD OF THE INVENTION

The present invention relates to an uninterrupted transfer method in an IP network in the event of a line failure, preventing the occurrence of packet loss the moment a line becomes faulty due to a line break, etc.

### BACKGROUND OF THE INVENTION

FIG. 1 shows an explanation diagram of a conventional example of packet transfer in a network.

The example illustrates that, in ordinary cases, data are downloaded from a server 1 to a PC user terminal 2 in a route A passing through routers R1, R2, R3 in a network 3.

In FIG. 1, during this downloading, when a line break occurs at a route point A-a, the data become invalid because of an incomplete download (loss of packets). In this case, by requesting for retransmission from a user having been aware of the above event, a route B passing through routers R1, R2, R4, R3 in network 3 is established, and thus downloading from server 1 is executed again.

In such a case as described above, the user of PC user terminal 2 feels stress from a large delay against the download operation. Also, even when protection such as retransmission by the protocol on PC user terminal 2 is taken, it is not possible to completely guarantee prevention of an accident such as damaging important data.

Namely, as shown in FIG. 1, in case a line failure occurs in the network, retransmission is performed between transmitting/receiving terminals (end to end) because packet loss occurs. This produces inconvenience to a network user such as ‘damage to the transfer data’, ‘a response delay’, etc.

### DISCLOSURE OF THE INVENTION

Accordingly, it is an object of the present invention to provide an uninterrupted transfer method, and a packet transmission apparatus using the same, for preventing the occurrence of packet loss in the event of a line failure, relieving packets once being lost the moment the failure occurs, and impeding an influence upon the packet communication between transmitting/receiving terminals (end to end) due to the occurrence of the line failure.

As an uninterrupted transfer method in the event of a line failure in an IP network according to the present invention to achieve the aforementioned object, in a first aspect of the uninterrupted transfer method in an event of a line failure in a transmission system performing packet transmission between transmission apparatuses connected by a plurality of lines, the uninterrupted transfer method includes: periodically transmitting test packets including the information of the number of received packets, from a transmission apparatus of transmission destination to a transmission apparatus of transmission source; in the transmission apparatus of transmission source, comparing the information of the number of received packets, which is included in each test packet received, with the number of packets transmitted to the transmission apparatus of transmission destination through a certain line; and, in the above comparison, when the number of received packets is inconsistent with the number of transmitted packets, the packets corresponding to the above inconsistency are retransmitted to the transmission apparatus of transmission destination, through a line different from the certain line.

As a second aspect of the uninterrupted transfer method in accordance with the present invention to achieve the aforementioned object, in the first aspect, the packets transmitted to the transmission apparatus of transmission destination are stored in a buffer memory before the transmission; and, in the above comparison, when the number of received packets is consistent with the number of transmitted packets, the packets corresponding to the consistent number stored in the buffer memory are released from the buffer memory.

As a third aspect of the uninterrupted transfer method in accordance with the present invention to achieve the aforementioned object, in the second aspect, user packets to be transmitted to the transmission apparatus of transmission destination are classified into a plurality of quality classes, and only the user packets classified to a predetermined quality class or higher are stored in the buffer memory.

As a fourth aspect of the uninterrupted transfer method in accordance with the present invention to achieve the aforementioned object, in the first aspect, the packets to be retransmitted through the line different from the certain line are retransmitted after being formed into a single packet by concatenating the packets to a maximum transmittable length.

As a fifth aspect of the uninterrupted transfer method in accordance with the present invention to achieve the aforementioned object, in the first aspect, when the packets are retransmitted through the line different from the certain line, the packet transfer bandwidth for retransmission is set evenly to the packet transfer bandwidth being in transmission through the different line.

The features of the present invention will become more apparent by the following description of the embodiments with the accompanied drawings.

### BRIEF DESCRIPTION OF THE DRAWINGS

FIG. 1 shows a diagram illustrating a conventional example of packet transfer in a network.

FIG. 2 shows a diagram illustrating a conceptual configuration of an uninterrupted transfer method in accordance with the present invention, in the event of a line failure in an IP network corresponding to FIG. 1.

FIG. 3 shows a diagram illustrating packet flow between an apparatus R1 and an apparatus R2 corresponding to the routers shown in FIG. 2.

FIG. 4 shows a diagram illustrating the operation of a conventional packet buffer 100.

FIG. 5 shows a diagram illustrating the operation of a packet buffer 100 according to the present invention.

FIG. 6 shows a diagram illustrating a mechanism of detecting a line failure in the present invention.

FIG. 7 shows a diagram illustrating a mechanism of restraining traffic increase by elongating a ‘test packet transmission period’.

FIG. 8 shows a diagram illustrating an embodiment to solve an inconvenience such that a large number of packets are to be transmitted at the time of packet retransmission.

FIG. 9 shows a diagram illustrating the processing in a concatenation controller 121.

FIG. 10 shows a diagram illustrating an embodiment to prevent an indiscriminate packet discard in case of a temporary and abrupt load increase on a line after switchover.

### DETAILED DESCRIPTION OF THE INVENTION

The preferred embodiment of the present invention is described hereinafter referring to the charts and drawings.

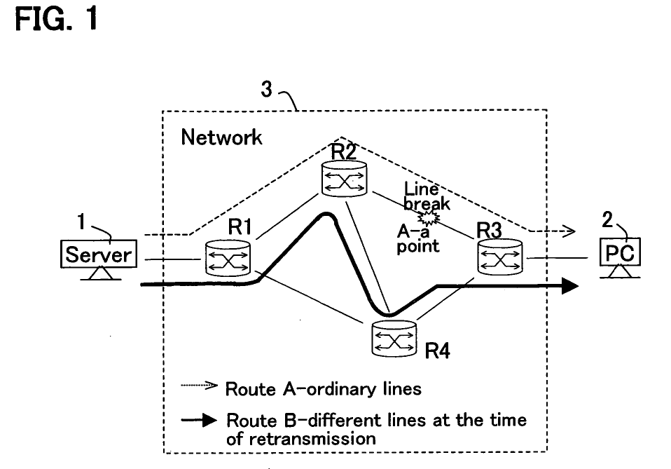

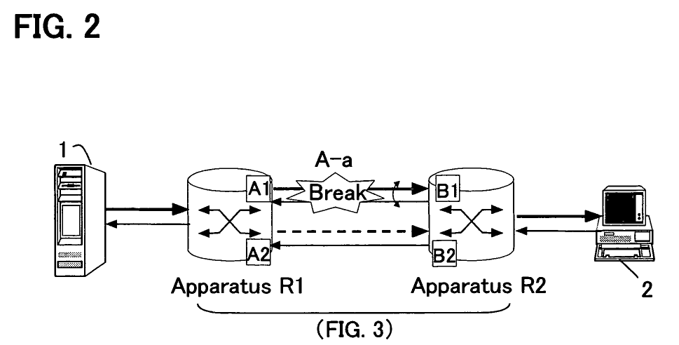

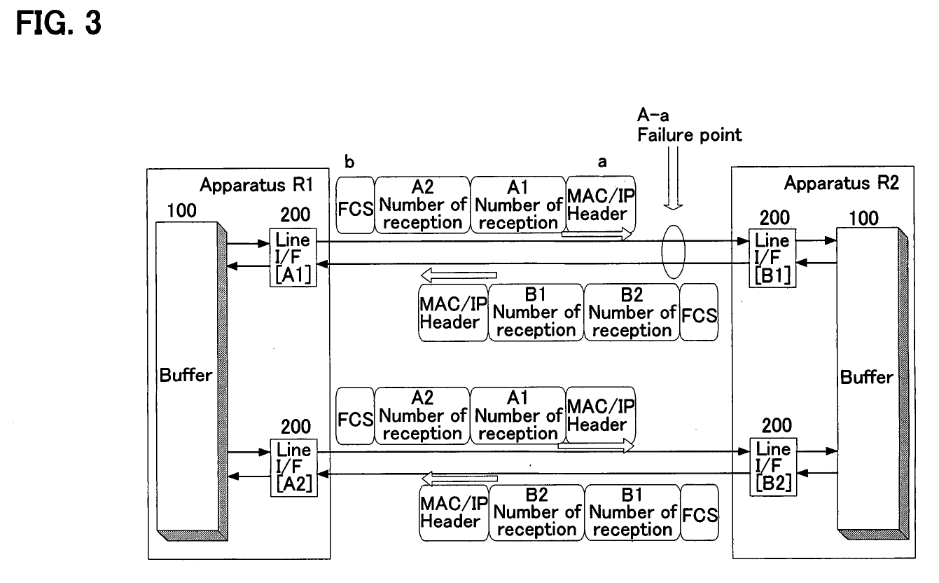

FIG. 2 is a diagram illustrating a conceptual configuration of an uninterrupted transfer method in the event of a line failure in an IP network corresponding to FIG. 1, in accordance with the present invention. FIG. 3 is a diagram illustrating packet flow between an apparatus R1 and an apparatus R2 which correspond to the routers shown in FIG. 2.

As shown in FIG. 3, each of the apparatus R1 and the apparatus R2 corresponding to the router includes a buffer memory 10, and a plurality of line interface circuits 200A1, A2-200B1, B2.

In the examples shown in FIG. 2 and FIG. 3, there are formed physical links connecting between a line interface 200A1 of a port A1 in the apparatus R1 and a line interface 200B1 of a port B1 in the apparatus R2, and between a line interface 200A2 of a port A2 in the apparatus R1 and a line interface 200B2 of a port B2 in the apparatus R2.

Here, it is considered that a line break occurs at a failure point A-a on the physical link between the ports A1 and B1.

On each physical link connecting interface 200A1 of the port A1 with interface 200B1 of the port B1, and connecting interface 200A2 of the port A2 with interface 200B2 of the port B2, user packets that include data information flow, as well as test packets that include information of the number of received packets in each port flow periodically.

As shown in FIG. 3, the test packets have information of the number of the packets received on each apparatus, being placed between a MAC/IP address header ‘a’ and a check code (FCS) ‘b’. On the two physical links 200A1-200B1 and 200A2-200B2 directing from the apparatus R1 to the apparatus R2, information c1, c2 of the number of received packets in two interface circuits 200A1, 200A2 of the apparatus R1 is included, as information of the number of received packets.

Similarly, on the two physical links 200B1-200A1 and 200B2-200A2 directing from the apparatus R2 to the apparatus R1, information d1, d2 of the number of received packets in the two interface circuits 200B1, 200B2 of the apparatus R2 is included, as information of the number of received packets.

Before the occurrence of a failure at the failure point A-a, a receiving section being connected to interface circuit 200B1 on the apparatus R2 side receives test packets which are periodically transmitted from a transmitting section being connected to interface circuit 200A1 on the apparatus R1 side. By this, it is confirmed that the physical link directing from interface circuit 200A1 to interface circuit 200B1 is normal.

Further, by the information d1 of the number of received packets included in the test packets which are transmitted from interface circuit 200B1, directed to interface circuit 200A1 and arriving at interface circuit 200A1, the number of user packets normally arriving at the port B1 of the apparatus R2, which are transmitted from the port A1 of the apparatus R1, is confirmed.

At this time, the portion of the packets corresponding to the received packets, of which reception at the apparatus R2 has been confirmed, are cleared from a buffer memory 100 in the apparatus R1, and the memory space having been occupied is released.

Further, in the test packets transferred between the ports B2 and A2, the information of the numbers of received packets at the ports A1, B1 are included, while in the test packets transferred between the ports B1 and A1, the information of the numbers of received packets at the ports A2, B2 are included.

On the occurrence of the failure at the failure point A-a, the test packets neither arrive at interface circuit 200A1 of the port A1 in the apparatus R1, nor at interface circuit 200B1 of the port B1 in the apparatus R2. By this, it is sensed that an abnormality has occurred on the physical link between the ports A1 and B1.

At this time point, because no information of the received packets at port B1 is included in the test packets being transmitted in the direction from the port B1 to the port A1, the user packets stored in buffer memory 100 of the apparatus R1 are retained without being cleared.

After the occurrence of the failure, for the number of packets received at the port B1 included in a test packet transmitted from the port B2 in the A2 direction, the user packets retained in buffer memory 100 of the apparatus R1 are cleared. The remainder is to be retransmitted using a normal physical link from the port A2 to the port B2 through diversion processing. Accordingly, duplication of transmission is restrained.

Through the above-mentioned procedure, the packet(s) being lost the moment the failure occurred is relieved by means of the retransmission. Thus, an influence upon the packet communication between the transmitting/receiving terminals (end to end) due to the line failure is impeded, and the uninterrupted protection can be achieved.

Here, according to the conventional method, packet loss inevitably occurs in the event of a line failure, and thereafter, retransmission processing between the transmitting/receiving terminals (end to end) is necessary, which produces inconvenience such as a delay and damaged data. In contrast, according to the embodiment of the present invention, prevention against packet loss is performed between the apparatuses on the occurrence of the line failure, and accordingly, such inconvenience as described above is not produced.

Now, in the above-mentioned uninterrupted transfer method according to the present invention, the relation between a ‘test packet transmission period’ and a ‘buffer capacity for retransmitting transmission packets’ becomes important.

If the ‘test packet transmission period’ is set short, test packet traffic is increased and line use efficiency is deteriorated. On the contrary, if the transmission period is set long, it takes a substantially long time before detecting the line failure, which necessitates an increased buffer capacity for retransmission, causing defects of increases in both cost and size of the apparatus.

Therefore, in the embodiment of the present invention, packets having particular QoS (Quality of Service) or higher are only retained in the buffer and complemented. With this, the buffer capacity increase is avoided, and the traffic increase can be restrained by elongating the ‘test packet transmission period’.

Further, in case of the retransmission, it becomes necessary to transmit both ordinary user packets and the packets for retransmission, causing a situation that a large number of packets are required for transmission in a short time. In this case, because the packet data for retransmission processing are existent in buffer 100 in a static state, edition of the packet data for retransmission is easy. Therefore, it is possible to concatenate (into a composite form) a plurality of short length packets to be retransmitted to the maximum length permitted, thereby making a single packet. Thus, it becomes possible to improve the line efficiency.

Also, as to the traffic in a bandwidth guarantee class among the traffic to have been transmitted on the original route before switchover, even after the occurrence of the line failure, the guaranteed bandwidth before the occurrence thereof is guaranteed. As to the minimum bandwidth guarantee class among the traffic on the original route before switchover, a minimum bandwidth guarantee value is limited to the bandwidth having been in use immediately before the occurrence of the line failure. Moreover, among the traffic on the original route before switchover, traffic of the non-guarantee class is preferentially discarded.

Similarly, in a physical link to be used for diversion in the retransmission processing, user traffic having been flowing from before the diversion is existent, needless to say. Therefore, when the line is switched over for diversion, as to the traffic of the bandwidth guarantee class among the traffic for transmission through a route after the switchover, it is also necessary to guarantee the guarantee class before the occurrence of the line failure, even after the occurrence of the line failure. Also, among the traffic for transmission through a route after the switchover, as to the non-guaranteed class, the traffic is preferentially discarded. As to the minimum bandwidth guarantee class, the minimum bandwidth guarantee value is restrained to the bandwidth having been used immediately before the occurrence of the line failure, while the non-guarantee class is preferentially discarded.

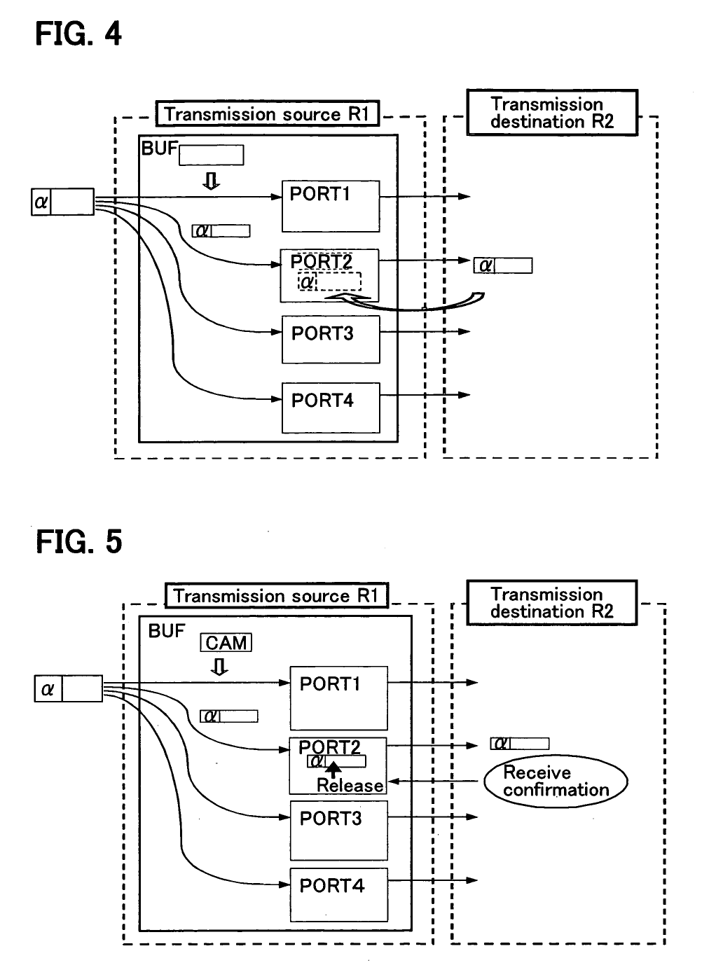

FIG. 4 is a diagram illustrating operation of the conventional packet buffer 100. In FIG. 4, a packet PK being input to a transmission apparatus R1 of transmission source is once stored into buffer memory 100, and on completion of the packet transmission, the buffer area of the packet information transmitted from the relevant port is released. In FIG. 4, the packet information transmitted from port 2 is deleted from the corresponding area.

In contrast, FIG. 5 is a diagram illustrating operation of packet buffer 100 according to the present invention. A packet being input to the transmission apparatus R1 of transmission source is once stored into buffer memory 100. Then, as having been illustrated in FIG. 3, the transmission apparatus R1 of transmission source receives, from the transmission destination, information of the number of the received packets, and after it is confirmed that the packets are normally received, the buffer area of the packet information concerned is released.

The following describes an embodiment for preventing packet loss in the event of a line failure by applying the conceptual configuration of the aforementioned present invention.

<Mechanism of Detecting a Line Failure>

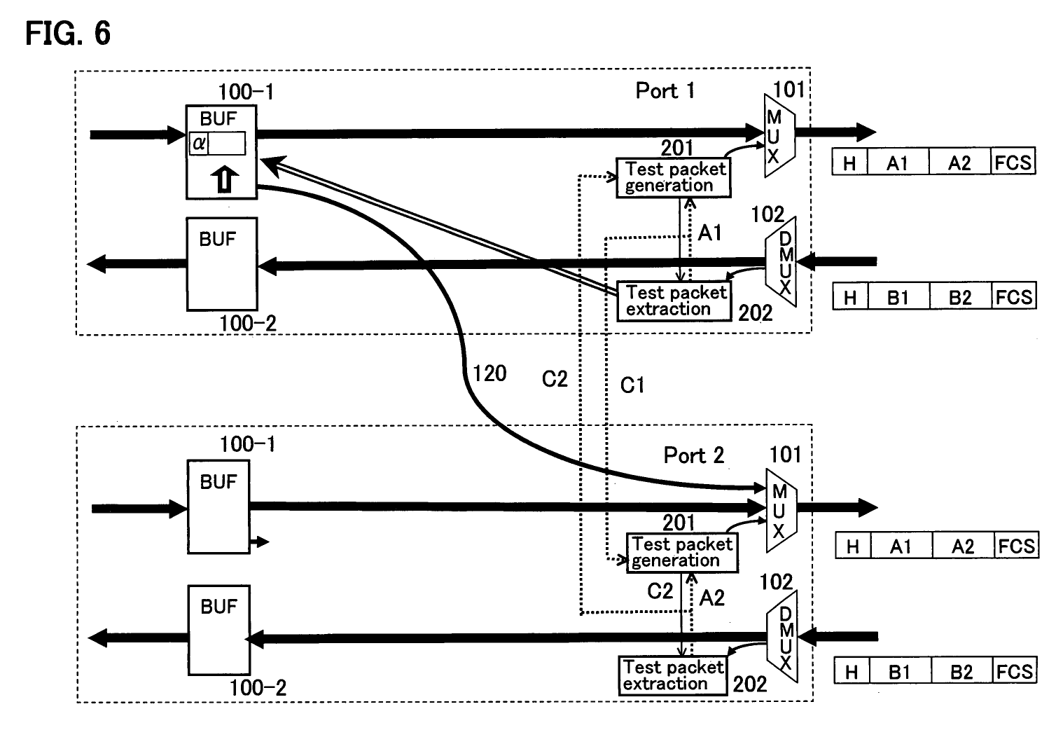

FIG. 6 is a diagram illustrating a mechanism of detecting a line failure in accordance with the present invention. Here, in FIG. 6, only an interface section in the apparatus R1 on a single side is shown, which is also the same for the opposite apparatus R2. Also, referencing a transmission direction of a one-way packet, it is described for the sake of convenience such that the apparatus R1 is a transmission apparatus on the transmission source, while the apparatus R2 is a transmission apparatus on the transmission destination. The above is also similar to the succeeding embodiments.

According to the present invention, first, as the function of detecting a line failure between apparatuses, test packets are transmitted, at a constant period, mutually between the transmission apparatus R1 of transmission source and the transmission apparatus R2 of transmission destination.

In a test packet to be transmitted from the transmission apparatus R1 of transmission source to the transmission apparatus R2 of transmission destination, the number of user packets (A1 at port 1, and A2 at port 1) received in the transmission apparatus R1 is included. On the other hand, in a test packet to be transmitted from the transmission apparatus R2 of transmission destination to the transmission apparatus R1 of transmission source, the number of user packets (B1 at port 1, B2 at port 1) received in the transmission apparatus R1.

The format of such a test packet is composed of a header (H), a check part (FCS), and information of the number of received packets A1, A2, B1, B2 inserted therebetween, as shown in the figure.

In FIG. 6, each of port 1 and port 2 in the interface section includes a test packet generator 201 for generating the above-mentioned test packet, and a test packet extractor 202 for extracting the test packet transmitted from the transmission apparatus R2 of transmission destination. Further, each port 1, 2 includes a buffer memory 100-1 on the transmission side (hereafter, simply referred to as buffer), a buffer memory 100-2 on the reception side (hereafter, simply referred to as buffer) a multiplexer 101 and a demultiplexer 102.

After transmitting the above-mentioned test packet, test packet generator 201 counts and monitors the number of transmitted user packets (the number of packets C1 transmitted from port 1, and the number of packets C2 transmitted from port 2) being read out from buffer 100-1 on the transmission side in the transmission apparatus R1 of transmission source, using a counter, during the period until the next test packet is transmitted. The result of the above count and monitor is notified to test packet extractor 202.

Accordingly, in test packet extractor 202, the number of packets to be received by transmission apparatus R2 of transmission destination is grasped (the numbers of transmission packets C1, C2 counted by the counter in test packet generator 201 have been notified to test packet extractor 202). Accordingly, the numbers of received packets (B1 at port 1, and B2 at port 2) which are included in the test packet transmitted from the transmission apparatus R2 of transmission destination are compared with the numbers of the transmitted packets (C1 at port 1, and C2 at port 2). When inconsistency is found in this comparison, a line failure can be detected.

For example, in the case that the number of packets (B1) received at port 1 of the transmission apparatus R2 of transmission destination, which is included in the test packet received by the transmission apparatus R1 of transmission source from the transmission apparatus R2 of transmission destination, equals to the number of packets (C1) having been transmitted from port 1 of the transmission apparatus R1 of transmission source directed to port 1 of the transmission apparatus R2 of transmission destination, it can be recognized that packet transmission/reception has normally been performed at port 1 of transmission apparatus R2 of transmission destination.

At this time, in transmission apparatus R1 of transmission source, the corresponding packet information a having been retained in transmission buffer 100-1 is released, as the normal packet transmission/reception has been recognized.

On the contrary, in the case that the number of packets (B1) received at port 1 of the transmission apparatus R2 of transmission destination, which is included in the test packet received by the transmission apparatus R1 of transmission source is smaller than the number of packets (C1) having been transmitted from port 1 of the transmission apparatus R1 of transmission source to port 1 of transmission apparatus R2 of transmission destination (or unable to receive), it is recognized that a line failure has occurred between port 1 of the transmission apparatus R1 of transmission source and port 1 of the transmission apparatus R2 of transmission destination. At this time, the corresponding packet information α having been retained in buffer 100-1 is read out (120), and the packet is retransmitted 1 through a different line connected to port 2 of transmission apparatus R1 of transmission source.

<Mechanism of Detecting the Number of Lost Packets>

Here, on detecting the line failure as described above, the number of lost packets due to the line failure is calculated. This calculation of the lost packets is obtained by a difference between the number of packets (C1) transmitted from transmission apparatus R1 of transmission source to transmission apparatus R2 of transmission destination, which is counted in test packet generator 201, and the number of packets to be received by transmission apparatus R2 of transmission destination.

For example, when a line failure has occurred between the transmission apparatus R1 of transmission source and the transmission apparatus R2 of transmission destination, assuming it is notified that the number of received packets is (B1), from the transmission apparatus R2 of transmission destination through a test packet, the number of lost packets becomes (C1−B1). At this time, as to the number of received packets (B1), it is signified that packet communication has been performed normally, and the packets corresponding to the number of packets (B1) having been retained in buffer 100-1 are released.

As to the remainder of the packets (C1−B1), the information of the corresponding number of packets (C1−B1) having been retained in buffer 100-1 is retransmitted through a different line connected to port 2. This results in making it possible to prevent packet loss caused by the line failure.

Here, in the above embodiment, the relation between a ‘test packet transmission period’ and a ‘buffer capacity for retransmitting transmission packets’ becomes important.

If the ‘test packet transmission period’ is set short, test packet traffic is increased and line use efficiency is deteriorated. On the contrary, if the transmission period is set long, it takes a substantially long time before detecting the line failure, which necessitates an increased buffer capacity for retransmission, causing defects of increases in both cost and size of the apparatus.

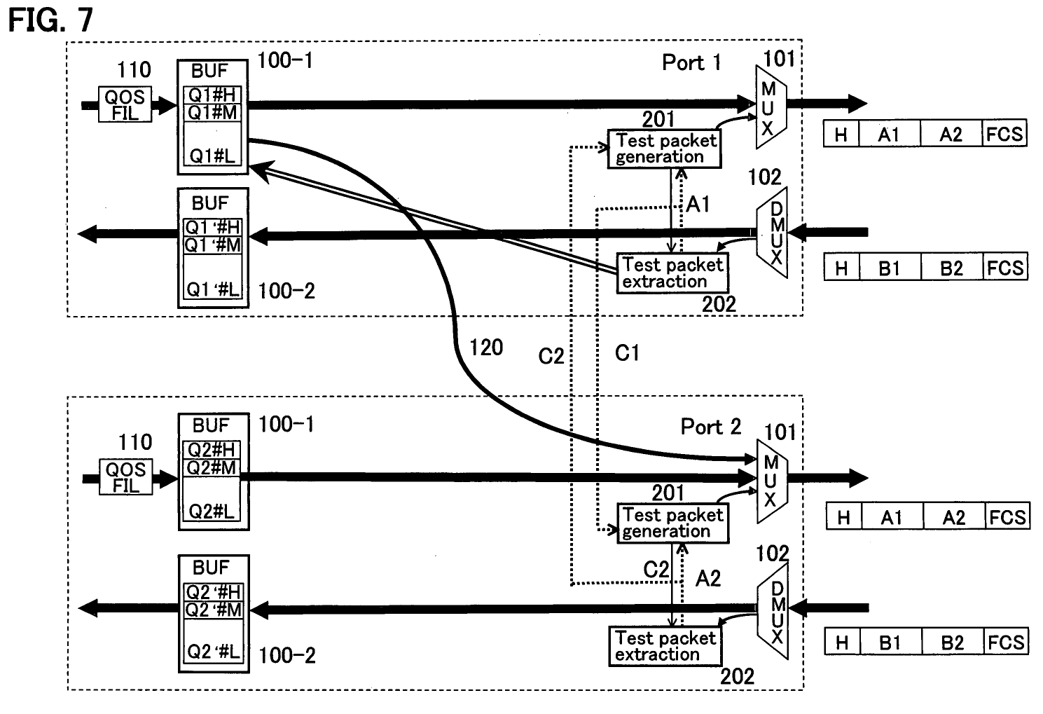

Therefore, packets of particular QoS or more are only retained in buffer 100-1 and complemented. With this, an increase of the buffer capacity can be avoided. Referring to FIG. 7, the above mechanism of restraining the traffic increase by elongating the ‘test packet transmission period’ is described.

Namely, the packet types input to the interface section are classified into Q1#H (a bandwidth guarantee class of port 1 of the transmission apparatus R1 of transmission source), Q1#M (a minimum bandwidth guarantee class of port 1 of the transmission apparatus R1 of transmission source), and Q1#L (anon-guarantee class of port 1 of the transmission apparatus R1 of transmission source).

For this purpose, a QoS filter 110 is provided in the preceding stage of buffer 100-1. Using this filter 110, the guarantee in the event of a line failure is sorted according to the aforementioned packet types.

At this time, the relation of the following formula is preset in such a way that a sorting ratio is determined as follows: The sum of the buffer capacity for the bandwidth guarantee class Q1#H and the buffer capacity for the minimum bandwidth guarantee class Q1#M becomes no greater than the buffer capacity occupied by the non-guarantee class Q1#L. Namely the formula is “Buffer retention (Q1#H+Q1#M)<Buffer non-retention (Q1#L)”.

As such, by limiting the packets of the bandwidth guarantee class (Q1#H+Q1#M) retained in buffer 100-1, it becomes possible to restrain capacity increase of buffer 100-1.

Furthermore, in FIG. 7, as for the packets of Q1#L (non-guarantee class of port 1 in the transmission apparatus R1 of transmission source), the packets are read out from buffer 100-1, and the buffer 100-1 is released after the packets are transmitted from transmission apparatus R1 of transmission source.

Meanwhile, only for the bandwidth guarantee classes (Q1#H and Q1#M), when the notification of packet information having normally been received in the transmission apparatus R2 of transmission destination is received in test packet extractor 202, buffer 100-1 is released, as having been described in FIG. 3.

At this time, when the notification of lost packet information due to a line failure is received in test packet extractor 202, the packet information concerned is retained in buffer 100-1, and is transmitted after switching to a different line (port 2). With this, it becomes possible to prevent a buffer capacity from becoming greatly increased, and to complement the lost packet due to the line failure of port 1.

Here, when realizing the packet retransmission, because the packets for retransmission have to be transmitted together with ordinary user packets, an amount of packets to be transmitted becomes large. Accordingly, it becomes necessary to transmit the packets in a short time.

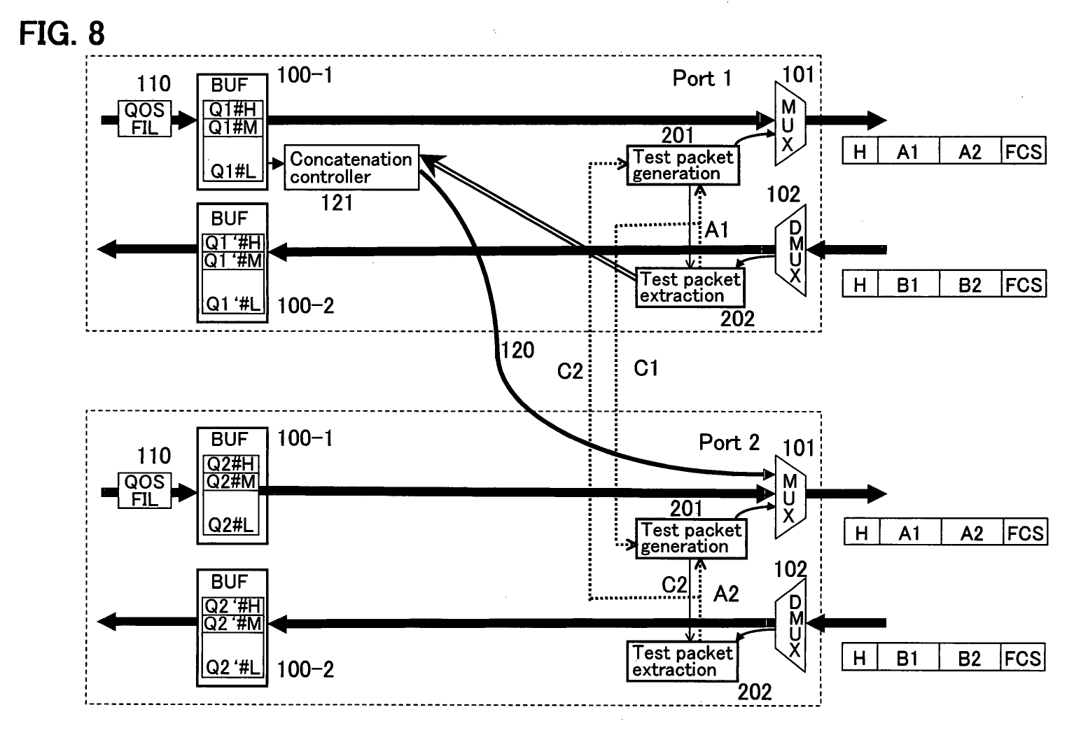

FIG. 8 is an embodiment to cope with the above situation. The feature is that a concatenation controller 121 is provided.

When retransmitting, because a large amount of packets are transmitted in a short time, short length packets are concatenated (into a composite form) to the size of a maximum transmittable packet length (MTU). Normally, as the packet structure to be transmitted, a header, check bits FCS, etc. are included together in each packet.

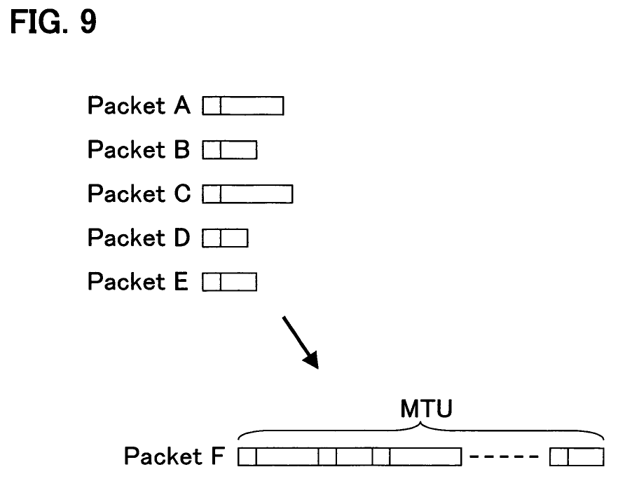

In concatenation controller 121, as shown in FIG. 9, a plurality of short length packets, for example, packets A, B, C, D, E are concatenated up to the size of a maximum possible transmittable packet length, for example, 1,522 bytes. By transmitting such a concatenated (composite) packet F, the bandwidth of the header, the FCS, etc. can be reduced for the number of concatenated packets (5 packets in the example shown in FIG. 9). By this, it is possible to retransmit a large amount of packets in a short time, without losing packets in the event of the line failure.

Here, when the line failure occurs and the retransmission is performed from buffer 100-1 retaining the packets of the difference between the transmission packets and the reception packets, using a different line connected to port 2, so as to complement the packets being lost due to the failure of the line concerned, a case of an abrupt load increase may temporarily occur at the different line in use after the switchover.

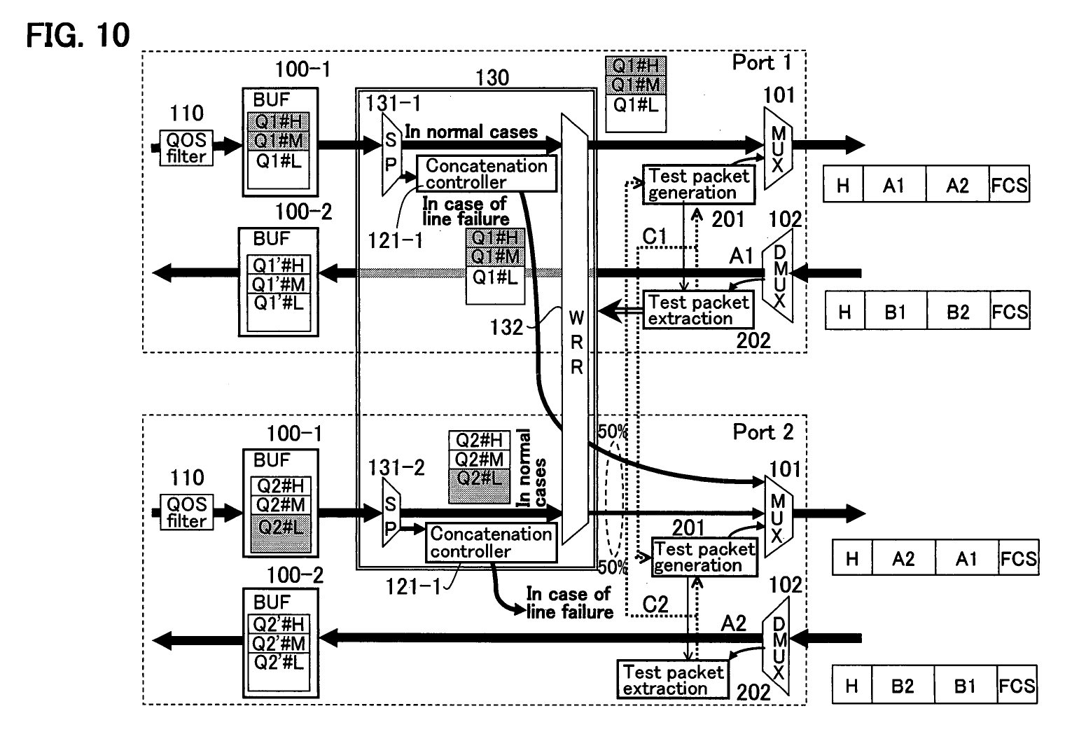

This situation may possibly produce indiscriminate packet discard. An embodiment for preventing such an inconvenience is shown in FIG. 10.

To cope with the above situation, in the embodiment shown in FIG. 10, there is provided a bandwidth guarantee means 130, which includes a priority processor 131 and a round robin section 132.

The packets being input from buffer 100-1 of port 1, which is the transmission source, to priority processor 131-1 are classified into the bandwidth guarantee class (Q1#H), the minimum bandwidth guarantee class (Q1#M), and the non-guarantee class (Q1#L).

The packets being input from buffer 100-1 on the port 2 side to be switched, to priority processor 131-2 are also classified into the bandwidth guarantee class (Q2#H), the minimum bandwidth guarantee class (Q2#M), and the non-guarantee class (Q2#L).

Here, priority processors 131-1, 131-2 preferentially transmit the packets of the bandwidth guarantee class (Q1#H at port 1, and Q2#H at port 2) and the packets of the minimum bandwidth guarantee class (Q1#M at port 1, and Q2#M at port 2). When there are no packets of the bandwidth guarantee class, nor the minimum bandwidth guarantee class, priority processors 131-1, 131-2 transmit the packets of the non-guarantee class (Q1#L at port 1, and Q2#L at port 2) outside the minimum bandwidth guarantee class.

In normal cases, the packets processed in priority processors 131-1, 131-2 are transmitted as they are, after passing through round robin (WRR) section 132.

In the event of a line failure, round robin (WRR) section 132 can change the ratio of the packets to be transmitted to each port.

Round robin (WRR) section 132 sets the maximum physical line speed corresponding to port 1 and port 2 to, for example, 1 Gbits/sec. In the normal cases, 100% packet transmission is set for port 1 and port 2, respectively.

Next, assuming a case that a line failure has occurred on port 1, the packets having been transmitted from port 1 at the time of the line failure are retransmitted from port 2. Namely, the packets for 2 Gbits/sec of both port 1 and port 2 will flow into port 2. However, since the maximum physical line speed is 1 Gbits/sec, the rest of 1 Gbits/sec are to be discarded, which may possibly cause discard of the guaranteed packets.

Therefore, in round robin section 132, 50% transmission is set for each of port 1 and port 2. With this, the line speed are set evenly for port 1 and port 2, and it becomes possible to prevent occurrence of discard of the bandwidth guarantee packet.

In FIG. 10, when a notification of line failure is received from test packet extractor 202, the packets processed in priority processor 131-1 are input to round robin section 132, after the packets are concatenated through concatenation controller 121 as shown in FIG. 9.

At this time, in port 2 being switched, in addition to the packets of Q2#H, Q2#M and Q2#L, which are originally to be transmitted therefrom, the packets of Q1#H, Q1#M and Q1#L which have been lost on port 1 due to the line failure are to be transmitted. If no further action is taken, the retransmission packets from port 1 and the original bandwidth guarantee packets on port 2 may possibly be discarded.

To cope with this, by setting the bandwidth ratio evenly in round robin 132 as described above, it becomes possible to transmit to the line both the retransmission packets from port 1 and the original bandwidth guarantee packets for transmission from port 2 without discarding.

With the above-mentioned method, neither the packets for bandwidth guarantee class on port 1 for retransmission, nor the packets for bandwidth guarantee class on port 2 being switched, are lost. Thus, the quality on port 1 and port 2 can be guaranteed, and the packets once being lost on port 1 due to the line failure can be complemented.

### INDUSTRIAL APPLICABILITY

According to the present invention, an increase of buffer capacity required for retransmission processing can be restrained. Also, an abrupt traffic increase produced by the retransmission processing can be relieved. With this, the uninterrupted transfer method in the event of a line failure in an IP network is provided, by which inconvenience of delay, data damage, etc. in the event of a line failure is eliminated.

1. An uninterrupted transfer method in an event of a line failure in a transmission system performing packet transmission between transmission apparatuses connected by a plurality of lines, comprising:
in a transmission apparatus of transmission destination, periodically transmitting packets including information of the number of packets received from a transmission apparatus of transmission source, from said transmission apparatus of transmission destination to said transmission apparatus of transmission source;
in the transmission apparatus of transmission source, comparing the information of the number of received packets, which is included in each packet received, with the number of packets transmitted to the transmission apparatus of transmission destination through a certain line; and
in the comparison, when the number of received packets is inconsistent with the number of transmitted packets, the packets corresponding to said inconsistency are retransmitted to the transmission apparatus of transmission destination, through a line different from the certain line.

2. The uninterrupted transfer method according to claim 1,
wherein the packets to be transmitted to the transmission apparatus of transmission destination are stored in a buffer memory before the transmission; and
in the comparison, when the number of received packets is consistent with the number of transmitted packets, the packets corresponding to the consistent number stored in the buffer memory are released from the buffer memory.

3. The uninterrupted transfer method according to claim 2,
wherein user packets to be transmitted to the transmission apparatus of transmission destination are classified into a plurality of quality classes, and only the user packets classified to a predetermined quality class or higher are stored in the buffer memory.

4. The uninterrupted transfer method according to claim 1,
wherein the packets to be retransmitted through the line different from the certain line are retransmitted after being formed into a single packet by concatenating to a maximum transmittable length.

5. The uninterrupted transfer method according to claim 1,
wherein, when the packets are retransmitted through the line different from the certain line, the packet transfer bandwidth for retransmission is set evenly to the packet transfer bandwidth being in transmission through the different line.

6. A packet transmission apparatus comprising:
a section comparing the number of packets transmitted from a certain line to a transmission apparatus of transmission destination with the number of received packets which is included in test packets periodically transmitted from the transmission apparatus of transmission destination; and
by the comparison, when there is a difference between the number of transmitted packets and the number of received packets included in each test packet, a section transmitting the packets corresponding to the difference to the transmission apparatus of transmission destination through a line different from the certain line.

7. The packet transmission apparatus according to claim 6, further comprising:
a buffer memory storing the packets to be transmitted to the transmission apparatus of transmission destination, before the transmission,
wherein, in the comparison, when the number of received packets is consistent with the number of transmitted packets, the packets stored in the buffer memory are released from the buffer memory.

8. The packet transmission apparatus according to claim 7,
wherein the buffer memory stores only a user packet having a predetermined quality class, or higher, among the user packets to be transmitted to the transmission apparatus of transmission destination.

9. The packet transmission apparatus according to claim 6, further comprising:
a section forming a single packet by concatenating the packets, which are to be retransmitted through the different line from the certain line, to a maximum transmittable length.

10. The packet transmission apparatus according to claim 6, further comprising:
when retransmitting the packets through the different line from the certain line, a section setting the packet transfer bandwidth for retransmission evenly to the packet transfer bandwidth being in transmission through the different line.
